(19) United States
(12) Patent Application Publication
(10) Pub. No.: US 2019/0149788 A1
(43) Pub. Date: May 16, 2019

(54) CALIBRATION METHOD OF DEPTH IMAGE CAPTURING DEVICE

(71) Applicant: INDUSTRIAL TECHNOLOGY RESEARCH INSTITUTE, Hsinchu (TW)

(72) Inventors: Tung-Fa Liou, Hsinchu City (TW); Shang-Yi Lin, Taichung City (TW)

(21) Appl. No.: 15/853,491

(22) Filed: Dec. 22, 2017

(30) Foreign Application Priority Data
Nov. 10, 2017 (TW) 106138862

(51) Int. Cl. H04N 9/31; G01B 11/25; G06T 7/50

(52) U.S. Cl. CPC H04N 9/3194; H04N 13/0425; G06T 7/50; G01B 11/2545; G01B 11/2504

(57) ABSTRACT

A calibration method of a depth image capturing device including a projecting device and an image sensing device is provided. At least three groups of images of a calibration board having multiple feature points are captured. Intrinsic parameters of the image sensing device are calibrated according to the at least three groups of images. Multiple sets of coordinate values of corresponding points corresponding to the feature points in a projection pattern of the projecting device are obtained. Intrinsic parameters of the projecting device are obtained by calibration. Multiple sets of three-dimensional coordinate values of multiple feature points are obtained. An extrinsic parameter between the image sensing device and the projecting device is obtained according to multiple sets of three-dimensional coordinate values, the multiple sets of coordinate values of corresponding points, the intrinsic parameters of the image sensing device, and the intrinsic parameters of the projecting device.

This application claims the benefit of Taiwan application Ser. No. 106138862, filed Nov. 10, 2017, the subject matter of which is incorporated herein by reference.

### BACKGROUND

### Technical Field

The disclosure relates in general to a calibration method of a depth image capturing device.

### Description of the Related Art

During the use of a depth camera, the original setting of calibration of the depth camera can be affected when the depth camera is hit, dropped off or under the influence of thermal expansion or contraction. Under such circumstances, the depth camera will be unable to calculate the depth of image, and the error in the depth of image calculated by the depth camera will increase. Such phenomenon is referred as calibration error.

When calibration error occurs to the depth camera, the depth camera needs to be sent to the manufacturer for calibration. After the manufacturer completes the calibration of the depth camera, the calibrated depth camera will be sent back to the user. However, such process is inconvenient to the user. Therefore, how to make the user calibrate the depth camera more conveniently has become a prominent task for the industries.

### SUMMARY

The disclosure is directed to a calibration method of a depth image capturing device. Through the use of a calibration board, the depth image capturing device can be calibrated without using a precise positioning calibration platform. Therefore, even when calibration error occurs to the depth image capturing device, the user still can perform calibration without sending the depth image capturing device back to the manufacturer or a professional calibration laboratory for calibration.

According to one embodiment of the disclosure, a calibration method of a depth image capturing device including a projecting device and an image sensing device is provided. The method includes the following steps. At least three groups of images of a calibration board having multiple feature points are captured. Intrinsic parameters of the image sensing device are calibrated according to the at least three groups of images. Multiple sets of coordinate values of corresponding points that corresponding to the feature points in a projection pattern of the projecting device are obtained. Intrinsic parameters of the projecting device are obtained by calibration. Multiple sets of three-dimensional coordinate values of multiple feature points are obtained. An extrinsic parameter between the image sensing device and the projecting device is obtained according to sets of three-dimensional coordinate values, the sets of coordinate values of corresponding points, the intrinsic parameters of the image sensing device, and the intrinsic parameters of the projecting device.

The above and other aspects of the disclosure will become better understood with regard to the following detailed description of the preferred but non-limiting embodiment(s). The following description is made with reference to the accompanying drawings.

### BRIEF DESCRIPTION OF THE DRAWINGS

FIG. 1 is a schematic diagram of a depth image capturing device according to an embodiment of the disclosure.

FIG. 2A is a flowchart of a calibration method of a depth image capturing device according to an embodiment of the disclosure.

FIG. 2B is a flowchart of a calibration method of a depth image capturing device according to another embodiment of the disclosure.

FIG. 3 is a schematic diagram of an image captured by a depth image capturing device according to an embodiment of the disclosure.

FIG. 4 is a flowchart of a calibration method of a depth image capturing device according to another embodiment of the disclosure.

FIG. 5 is a schematic diagram of an image captured by a depth image capturing device according to another embodiment of the disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION OF THE EMBODIMENTS

A number of embodiments disclosed below for detailed descriptions of the disclosure. However, descriptions of the embodiments are for exemplification purpose only, not for limiting the scope of protection of the present disclosure. Furthermore, some elements are omitted in the accompanying drawings of the embodiments to clearly illustrate technical features of the disclosure. Designations common to the accompanying drawings are used to indicate identical or similar elements.

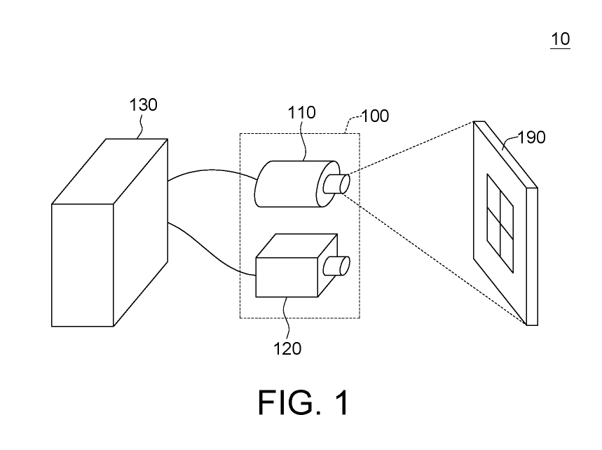

Referring to FIG. 1, a schematic diagram of a depth image capturing device 10 according to an embodiment of the disclosure is shown. The depth image capturing device 10 includes a three-dimensional image module 100 and a processing unit 130. The three-dimensional image module 100 includes a projecting device 110 and an image sensing device 120. In the three-dimensional image module 100, the relative distance and the relative angle between the projecting device 110 and the image sensing device 120 is fixed. The projecting device 110 projects a projection pattern on a calibration board 190. The projection pattern can be a pattern with a random distribution of scattered light spots and is referred as a random pattern image. In an embodiment of the disclosure, the projecting device 110 can be regarded as a virtual camera, and the projection pattern can be regarded as an image captured by the projecting device 110 (a virtual camera). The projecting device 110 can be realized by an optical projecting device or a digital projecting device.

The image sensing device 120 captures an image of the calibration board 190 and captures an image of the projection pattern projected on the calibration board 190 by the projecting device 110. The image sensing device 120 can be realized by such as a camera, a video camera or other devices capable of capturing an image. The calibration pattern of the calibration board 190 may include the shape of a window, a checkerboard, multiple concentric circles, or multiple circles. It should be understood that the calibration pattern is not limited thereto. The window of the window shaped calibration pattern is formed of multiple line segments. Each intersection of the line segments forms a feature point, and the multiple feature points are arranged as a 3×3 matrix of the calibration board 190. The calibration pattern of the calibration board 190 has a flat surface. In an embodiment of the disclosure, the calibration method of the depth image capturing device 10 is performed by a calibration board having a window shaped calibration pattern. However, anyone ordinarily skilled in the technology field of the disclosure will understand that the calibration pattern of the calibration board 190 is not limited to a window shape, and the calibration method of the depth image capturing device 10 can also be performed by the calibration board having other calibration patterns.

The image captured by the image sensing device 120 and the projection pattern of the projecting device 110 can be transmitted to the processing unit 130. The processing unit 130 performs calibration on the depth image capturing device 10 according to the image captured by the image sensing device 120 and the projection pattern of the projecting device 110. The processing unit 130 can be realized by a chip, a circuit block inside a chip, a firmware circuit, a circuit board having multiple electronic elements and wires or a storage medium storing multiple programming codes, and can also be realized by an electronic device (such as a computer system or a server) performing a corresponding software or program.

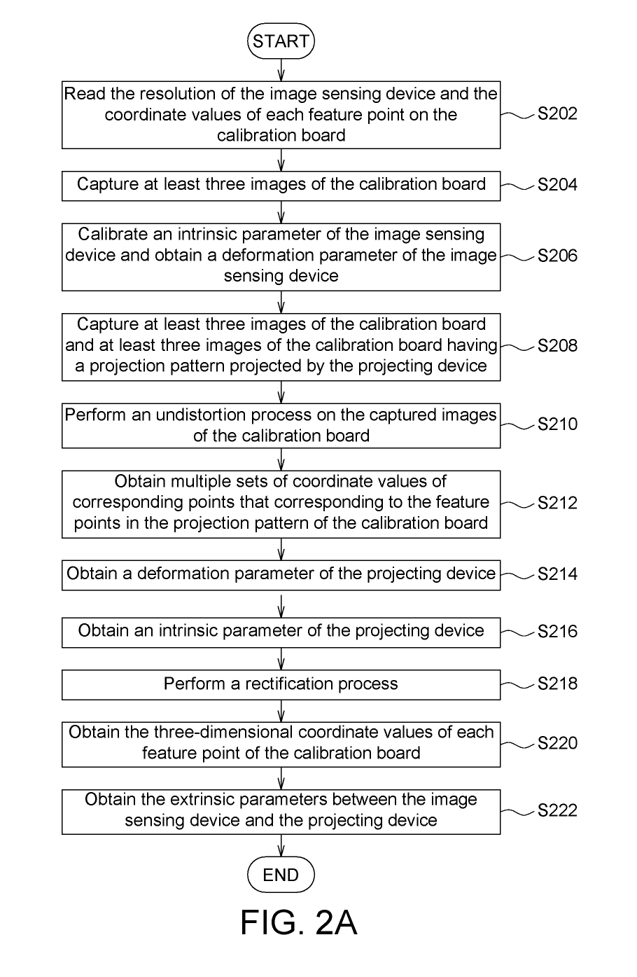

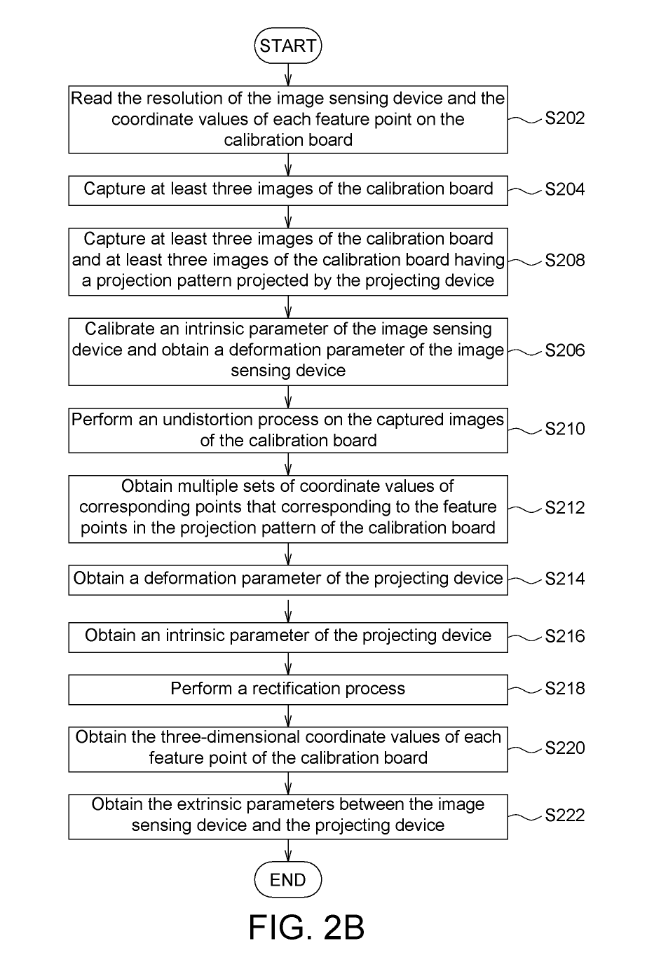

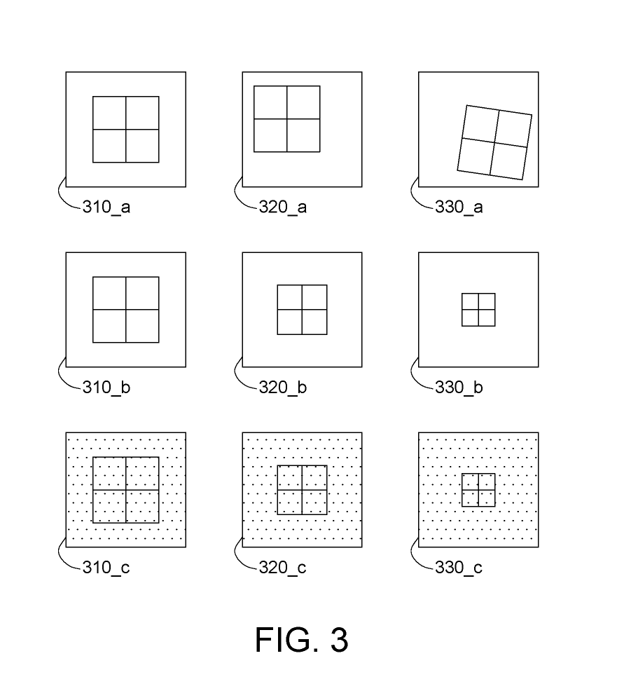

Refer to FIG. 1, FIG. 2A and FIG. 3. FIG. 2A is a flowchart of a calibration method of a depth image capturing device according to an embodiment of the disclosure. The calibration method of a depth image capturing device of FIG. 2A can be used in the depth image capturing device 10 of FIG. 1. To clearly describe the operations of above elements and the calibration method of a depth image capturing device according to an embodiment of disclosure, the flowchart of FIG. 2A is described below. However, anyone ordinarily skilled in the technology field of the disclosure will understand that the calibration method of a depth image capturing device according to an embodiment of the disclosure is not limited to being used in the depth image capturing device 10 of FIG. 1 and is not subjected to the sequence of steps exemplified in the flowchart of FIG. 2A. FIG. 3 is a schematic diagram of an image captured by a depth image capturing device according to an embodiment of the disclosure.

According to an embodiment of the disclosure, firstly, the method begins at step S202, the processing unit 130 reads the resolution of the image sensing device 120, the size of the calibration board 190, the distance between the feature points of the calibration board 190, and the coordinate values of each feature point on the calibration board 190. The above information can be read by the processing unit 130 reading a configuration file or can be inputted by the user or the calibration person.

In step S204, the image sensing device 120 faces the calibration board 190 from at least three different angles, and captures at least three images of the calibration board 190 from different angles. The image sensing device 120 captures a first angle image 310_a of the calibration board 190 from a first angle, a second angle image 320_a of the calibration board 190 from a second angle and a third angle image 330_a of the calibration board 190 from a third angle, respectively. The first angle, the second angle and the third angle are different from each other. By detecting the feature points, the processing unit 130 obtains the position (coordinate values) of each feature point in the first angle image 310_a, the second angle image 320_a and the third angle image 330_a of the calibration board 190, respectively.

Then, the method proceeds to step S206, the processing unit 130 calibrates an intrinsic parameter of the image sensing device 120 according to the first angle image 310_a, the second angle image 320_a and the third angle image 330_a. The processing unit 130 calibrates the intrinsic parameters of the image sensing device 120 according to formula 1 expressed below.

$$s [ \begin{matrix}X \\ Y \\ 1\end{matrix} ] = [ \begin{matrix}α & γ & {u}_{0} \\ 0 & β & {v}_{0} \\ 0 & 0 & 1\end{matrix} ] [ {\underline{r}}_{1} \vert {\underline{r}}_{2} \vert {\underline{r}}_{3} \vert \underline{t} ] [ \begin{matrix}x \\ y \\ z \\ 1\end{matrix} ] \qquad ( formula 1 )$$

The notations x, y, z are the three-dimensional coordinate values of the three-dimensional point (x, y, z) in the World Coordinate System determined by the user. The notations X, Y are the coordinate values of the corresponding two-dimensional point (X, Y) of the three-dimensional point (x, y, z) in a planar image. Intrinsic parameters α, β, γ, u₀, v₀ of the image sensing device 120 form a 3×3 matrix (a projection matrix of the image sensing device 12). Extrinsic parameters r₁, r₂, r₃, t of the image sensing device 120 form a 3×4 coordinate transformation matrix, and each of r₁, r₂, r₃, t is a 3×1 vector. The three orthogonal unit vectors r₁, r₂, r₃ form a rotation matrix, and are the rotation vectors of the image sensing device 120 on the x-axis, the y-axis, and the z-axis, respectively. The vector t is a translation vector of the image sensing device 120; the notation s is a scale coefficient.

When the image sensing device 120 captures the first angle image 310_a of the calibration board 190 from the first angle, the plane of the calibration board is defined as an xy plane in the World Coordinate System, and the z coordinate is defined as 0 (z=0), and the position of a first feature point in the first angle image 310_a of the calibration board 190 captured by the image sensing device 120 from the first angle is defined as an original point (0, 0, 0). Since the z coordinate is defined as 0 (z=0), formula 1 can be simplified, the unit vector r₃ can be removed, and formula 2 can be obtained as below.

$$s [ \begin{matrix}X \\ Y \\ 1\end{matrix} ] = [ \begin{matrix}α & γ & {u}_{0} \\ 0 & β & {v}_{0} \\ 0 & 0 & 1\end{matrix} ] [ {\underline{r}}_{1} \vert {\underline{r}}_{2} \vert \underline{t} ] [ \begin{matrix}x \\ y \\ 1\end{matrix} ] \qquad ( formula 2 )$$

α, β, γ, u₀, v₀ have nothing to do with the rotation or translation of the image sensing device 120, and therefore can be resolved to obtain the intrinsic parameters of the image sensing device 120 according to the first angle image 310_a, the second angle image 320_a, the third angle image 330_a and formula 2. Given that the coordinate values of each feature point on the calibration board 190 are known, the rotation and translation of the image sensing device 120 between the first angle, the second angle, and the third angle can be calculated to obtain the data of r₁, r₂, r₃, t.

Besides, the image captured by the image sensing device 120 can be distorted or deformed due to the optical properties of the lens of the image sensing device 120. Given that the window shaped calibration pattern of the calibration board 190 has four edges and each edge is a straight line, the processing unit 130 can obtain the deformation parameters K₁, K₂, . . . of the image sensing device 120 according to formula 3, formula 4 and formula 5.

x_{d}=xᵤ(1+K₁r²+K₂r⁴+ . . . ) (formula 3)

y_{d}=yᵤ(1+K₁r²+K₂r⁴+ . . . ) (formula 4)

r=\sqrt{(xᵤ−x_{c})²+(yᵤ−y_{c})²} (formula 5)

The notations K₁, K₂ are deformation parameters of the image sensing device 120; the notations x_{d} and y_{d} are coordinate values of the points in the distorted image; the notations xᵤ and yᵤ are coordinate values of the points in the undistorted image; the notations x_{c} and y_{c} are coordinate values of the points at the center of the distorted image.

Then, the method proceeds to step S208, the image sensing device 120 captures at least three images of the calibration board 190 from at least three different positions and at least three images of the calibration board 190 having a projection pattern projected by the projecting device 110 as indicated in FIG. 3. In an embodiment of the disclosure, the depth image capturing device 10 is disposed at different positions, and the depth image capturing device 10 disposed at different positions is separated from the calibration board 190 by different distances, but faces the calibration board 190 at the same angle. In another embodiment of the disclosure, the depth image capturing device 10 at different positions is separated from the calibration board 190 by different distances and faces the calibration board 190 at different angles.

The depth image capturing device 10 is disposed at a first position separated from the calibration board 190a by a first distance. That is, the depth image capturing device 10 disposed at the first position is separated from the calibration board 190 by a first distance. At the first position, the image sensing device 120 captures a first position image 310_b of the calibration board 190. Then, the depth image capturing device 10 is still at the first position, and the projecting device 110 projects a projection pattern on the calibration board 190. The image sensing device 120 senses and captures the image of the projection pattern projected on the calibration board 190 to generate a first position projection image 310_c.

Then, the depth image capturing device 10 is disposed at a second position separated from the calibration board 190a by a second distance. That is, the depth image capturing device 10 disposed at the second position is separated from the calibration board 190 by a second distance. At the second position, the image sensing device 120 captures a second position image 320_b of the calibration board 190. Then, the depth image capturing device 10 is still at the second position, and the projecting device 110 projects a projection pattern on the calibration board 190. The image sensing device 120 senses and captures the image of the projection pattern projected on the calibration board 190 to generate a second position projection image 320_c.

Then, the depth image capturing device 10 is disposed at a third position separated from the calibration board 190a by a third distance. That is, the depth image capturing device 10 disposed at the third position is separated from the calibration board 190 by a third distance. At the third position, the image sensing device 120 captures a third position image 330_b of the calibration board 190. Then, the depth image capturing device 10 is still at the third position, and the projecting device 110 projects a projection pattern on the calibration board 190. The image sensing device 120 senses and captures the image of the projection pattern projected on the calibration board 190 to generate a third position projection image 330_c. The first distance, the second distance and the third distance are different from each other.

In an embodiment of the disclosure, the first angle image 310_a, the first position image 310_b and the first position projection image 310_c can be regarded as a first set of images of the calibration board 190 captured by the image sensing device 120; the second angle image 320_a, the second position image 320_b and the second position projection image 320_c can be regarded as a second set of images of the calibration board 190 captured by the image sensing device 120; the third angle image 330_a, the third position image 330_b and the third position projection image 330_c can be regarded as a third set of images of the calibration board 190 captured by the image sensing device 120.

In step S210, the processing unit 130 performs an undistortion process on the first position image 310_b, the second position image 320_b, the third position image 330_b, the first position projection image 310_c, the second position projection image 320_c and the third position projection image 330_c of the calibration board 190 according to the above deformation parameters of the image sensing device 120 to generate a non-deformed first position image, a non-deformed second position image, a non-deformed third position image, a non-deformed first position projection image, a non-deformed second position projection image, and a non-deformed third position projection image.

In step S212, a first set, a second set, and a third set of coordinate values of corresponding points that corresponding to the feature points in the projection pattern of the calibration board 190 are obtained by a block matching algorithm according to the projection pattern, the non-deformed first position image, the non-deformed second position image, the non-deformed third position image, the non-deformed first position projection image, the non-deformed second position projection image, and the non-deformed third position projection image.

When the image sensing device 120 captures the first position image 310_b and the first position projection image 310_c, the depth image capturing device 10 is located at the first position. That is, the image sensing device 120 and the projecting device 110 are not moved. Therefore, the projection pattern can be compared with the non-deformed first position projection image by a block matching algorithm to obtain multiple coordinate values of corresponding points (the first set of coordinate values of corresponding points) corresponding to the multiple feature points in the projection pattern of the calibration board 190. Similarly, when the image sensing device 120 captures the second position image 320_b and the second position projection image 320_c, the depth image capturing device 10 is located at the second position. Therefore, the projection pattern can be compared with the non-deformed second position projection image by a block matching algorithm image to obtain multiple coordinate values of corresponding points (the second set of coordinate values of corresponding points) corresponding to the multiple feature points in the projection pattern of the calibration board 190. When the image sensing device 120 captures the third position image 330_b and the third position projection image 330_c, the depth image capturing device 10 is located at the third position. Therefore, the projection pattern can be compared with the non-deformed third position projection image by a block matching algorithm image to obtain multiple coordinate values of corresponding points (the third set of coordinate values of corresponding points) corresponding to the multiple feature points in the projection pattern of the calibration board 190.

In step S214, a deformation parameter of the projecting device 110 is obtained. Since the first position image 310_b, the second position image 320_b, the third position image 330_b, the first position projection image 310_c, the second position projection image 320_c, and the third position projection image 330_c have been processed with the undistortion process, a box having straight lines is defined on the above undistorted images. The box should also have straight lines in the three-dimensional space. Therefore, a box can be defined on one of the non-deformed first position projection image, the non-deformed second position projection image, and the non-deformed third position projection image. The box has a rectangular shape. By corresponding the pixel points on the four edges of the box to the projection pattern, a corresponding box can be obtained on the projection pattern. When projecting the projection pattern, if the casting lens of the projecting device 110 makes the image projected on the calibration board 190 deformed, then the corresponding box of the projection pattern defined in one of the non-deformed first position projection image, the non-deformed second position projection image, and the non-deformed third position projection image can be a trapezoid instead of a rectangle. The deformation parameter of the projecting device 110 can be obtained through the calculation of formula 3, formula 4, and formula 5 according to the box defined according to one of the non-deformed first position projection image, the non-deformed second position projection image, the non-deformed third position projection image, and the corresponding box on the projection pattern.

Then, the method proceeds to step S216, an intrinsic parameter of the projecting device 110 is obtained through the calculation of formula 1 and formula 2 according to the first set, the second set and the third set of coordinate values of corresponding points obtained in step S212.

In step S218, a rectification process is performed using an image transformation matrix between the image sensing device 120 and the projecting device 110, wherein the image transformation matrix is obtained according to the first set, the second set and the third set of coordinate values of corresponding points. Since the image sensing device 120 and the projecting device 110 do not completely overlap in the three-dimensional image module 100, the image sensing device 120 and the projecting device 110 form an angle and are vertically or horizontally separated by a distance. The image captured by the image sensing device 120 is not parallel to the image plane of the image (projection pattern) captured by the projecting device 110 being used as a virtual camera. Through the rectification process, the two image planes will be parallel to and coplanar with each other, and the epipolar line corresponding to the two image planes will be a horizontal line. The inclination between the image captured by the image sensing device 120 and the projection pattern projected by the projecting device 110 can be rectified by the image transformation matrix.

Then, the method proceeds to step S220, the data of r₁, r₂, r₃, t of the first position image 310_b, the second position image 320_b and the third position image 330_b in the first position image 310_b and the first position projection image 310_c, the second position image 320_b and the second position projection image 320_c, and the third position image 330_b and the third position projection image 330_c can be obtained through the calculation of formula 1 according to the intrinsic parameters of the image sensing device and the coordinate values of each calibration point of the calibration board 190. Given that the data of α, β, γ, u₀, v₀ and r₁, r₂, r₃, t as well as the coordinate values of each feature point in the first position image 310_b, the second position image 320_b and the third position image 330_b of the calibration board 190 are known, the three-dimensional coordinate values of each feature point on the calibration board 190 can be obtained through the calculation of formula 1.

In step S222, a projection matrix between the image sensing device 120 and the projecting device 110 is obtained through the calculation of 6 according to the three-dimensional coordinate values of each feature point on the calibration board 190 obtained in step 220, the first, the second set and the third set of coordinate values of corresponding points corresponding to the feature points in the projection pattern, the intrinsic parameters of the image sensing device 120 and the intrinsic parameters of the projecting device 110. The projection matrix is formed of the extrinsic parameters between the image sensing device 120 and the projecting device 110.

$$s [ \begin{matrix}X \\ Y \\ 1\end{matrix} ] = [ \begin{matrix}{p}_{0} & {p}_{1} & {p}_{2} & {p}_{3} \\ {p}_{4} & {p}_{5} & {p}_{6} & {p}_{7} \\ {p}_{8} & {p}_{9} & {p}_{10} & 1\end{matrix} ] [ \begin{matrix}x \\ y \\ z \\ 1\end{matrix} ] \qquad ( formula 6 )$$

### Wherein,

$$[ \begin{matrix}{p}_{0} & {p}_{1} & {p}_{2} & {p}_{3} \\ {p}_{4} & {p}_{5} & {p}_{6} & {p}_{7} \\ {p}_{8} & {p}_{9} & {p}_{10} & 1\end{matrix} ]$$

is the projection matrix; p₀˜p₁₀ are parameters in the projection matrix.

Referring to FIG. 2B, a flowchart of a calibration method of a depth image capturing device according to another embodiment of the disclosure is shown. Identical or similar steps common to the calibration method of a depth image capturing device of FIG. 2B and the calibration method of a depth image capturing device of FIG. 2A are designated by identical designations. The calibration method of a depth image capturing device of FIG. 2B is different from the calibration method of a depth image capturing device of FIG. 2A mainly in that step S208 can be performed before step S206. That is, before the intrinsic parameters of the image sensing device 120 are calibrated, the image sensing device 120 can capture at least three images of the calibration board 190 at three different positions and at least three images of the calibration board 190 having a projection pattern projected by the projecting device 110.

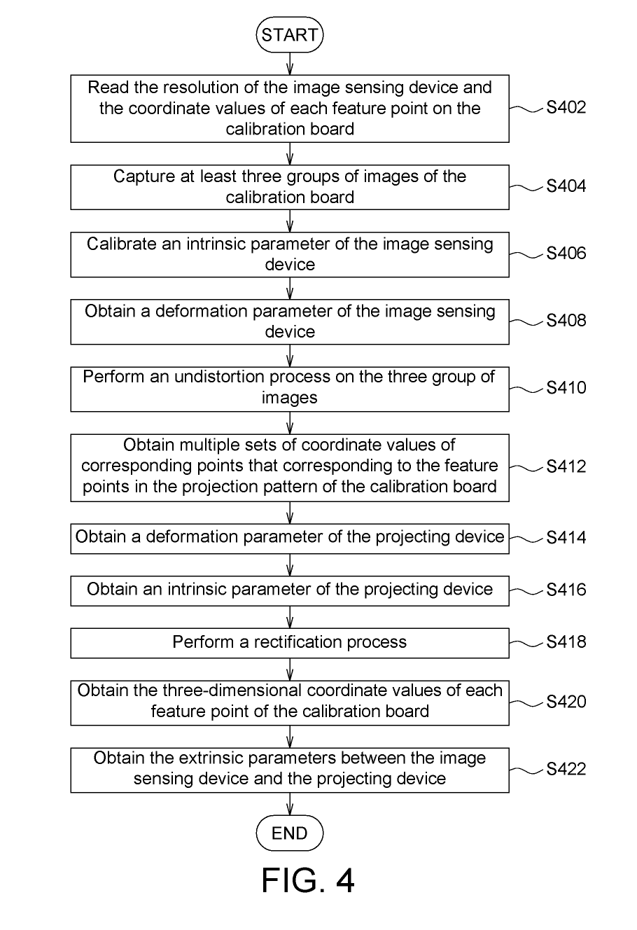

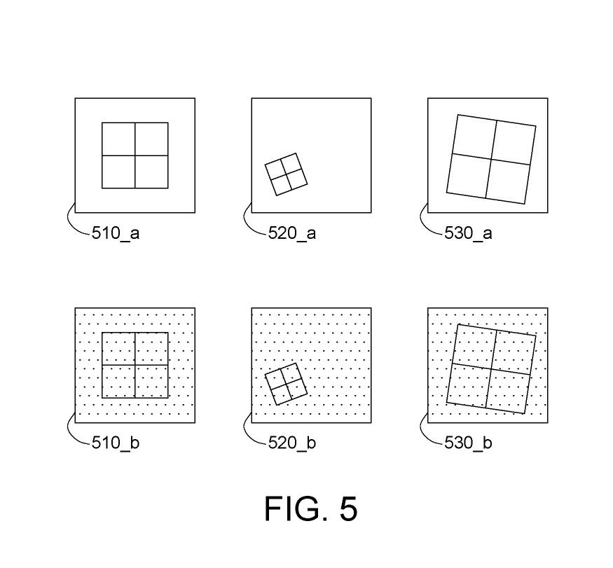

Refer to FIG. 1, FIG. 4 and FIG. 5. FIG. 4 is a flowchart of a calibration method of a depth image capturing device according to another embodiment of the disclosure. The calibration method of a depth image capturing device of FIG. 4 can be used in the depth image capturing device 10 of FIG. 1. To clearly describe the operations of above elements and the calibration method of a depth image capturing device according to an embodiment of disclosure, the flowchart of FIG. 4A is described below. However, anyone ordinarily skilled in the technology field of the disclosure will understand that the calibration method of a depth image capturing device according to an embodiment of the disclosure is not limited to being used in the depth image capturing device 10 of FIG. 1 and is not subjected to the sequence of steps exemplified in the flowchart of FIG. 4. FIG. 5 is a schematic diagram of an image captured by a depth image capturing device according to an embodiment of the disclosure.

According to an embodiment of the disclosure, firstly, the method begins at step S202, the processing unit 130 reads the resolution of the image sensing device 120, the size of the calibration board 190, the distance between the feature points of the calibration board 190, and the coordinate values of each feature point on the calibration board 190. The above information can be read by the processing unit 130 reading a configuration file or can be inputted by the user or the calibration person.

In step S404, the image sensing device 120, in at least three different states, captures at least three images of the calibration board 190 and at least three images of the calibration board 190 having a projection pattern projected by the projecting device 110 as indicated in FIG. 5.

Detailed descriptions of step S404 are disclosed below. Firstly, the depth image capturing device 10 is disposed in a first state. In the first state, the depth image capturing device 10 faces the calibration board 190 from a first angle and is separated from the calibration board 190 by a first distance. When the depth image capturing device 10 is in the first state, the image sensing device 120 captures a first state image 510_a of the calibration board 190, and the projecting device 110 projects a projection pattern on the calibration board 190. The image sensing device 120 senses and captures the image of the projection pattern on the calibration board 190 to generate a first state projection image 510_b.

Then, the depth image capturing device 10 is disposed in a second state. In the second state, the depth image capturing device 10 faces the calibration board 190 from a second angle, and the depth image capturing device 10 is separated from the calibration board 190 by a second distance. When the depth image capturing device 10 is disposed in the second state, the image sensing device 120 captures a second state image 520_a of the calibration board 190, and the projecting device 110 projects a projection pattern on the calibration board 190. The image sensing device 120 senses and captures the image of the projection pattern on the calibration board 190 to generate a second state projection image 520_b.

Then, the depth image capturing device 10 is disposed in a third state. In the third state, the depth image capturing device 10 faces the calibration board 190 from a third angle and is separated from the calibration board 190 by a third distance. When the depth image capturing device 10 is disposed in the third state, the image sensing device 120 captures a third state image 530_a of the calibration board 190, and the projecting device 110 projects a projection pattern on the calibration board 190. The image sensing device 120 senses and captures the image of the projection pattern on the calibration board 190 to generate a third state projection image 530_b. The said first distance, the second distance and the third distance are not the same, the first angle, the second angle and the third angle are not the same.

In an embodiment of the disclosure, the first state image 510_a, the first state projection image 510_b can be regarded as a first set of images of the calibration board 190 captured by the image sensing device 120; the second state image 520_a, the second state projection image 520_b can be regarded as a second set of images of the calibration board 190 captured by the image sensing device 120; the third state image 530_a, the third state projection image 530_b can be regarded as a third set of images of the calibration board 190 captured by the image sensing device 120.

In step S406, by detecting the feature points, the processing unit 130 obtains the position (coordinate value) of each feature point in the first state image 510_a, the second state image 520_a and the third state image 530_a on the calibration board 190, respectively. The processing unit 130 calibrates an intrinsic parameter of the image sensing device 120 according to the first state image 510_a, the second state image 520_a, and the third state image 530_a. The processing unit 130 calibrates the intrinsic parameters of the image sensing device 120 through the calculation of formula 1 and formula 2. In step S408, the deformation parameters of the image sensing device 120 are obtained through the calculation of formula 3, formula 4 and formula 5. Steps S406 and S408 of FIG. 4A are similar to step S206 of FIG. 2A, and the similarities are not repeated here.

In step S410, the processing unit 130 performs an undistortion process on the first state image 510_a, the second state image 520_a, the third state image 530_a, the first state projection image 510_b, the second state projection image 520_b and the third state projection image 530_b according to the deformation parameters of the image sensing device 120 obtained in step 408 to generate a non-deformed first state image, a non-deformed second state image, a non-deformed third state image, a non-deformed first state projection image, a non-deformed second state projection image, and a non-deformed third state projection image.

In step S412, a first set, a second set, and a third set of coordinate values of corresponding points corresponding to multiple feature points in a projection pattern of the calibration board 190 are obtained by a block matching algorithm according to the projection pattern, the non-deformed first state image, the non-deformed second state image, the non-deformed third state image, the non-deformed first state projection image, the non-deformed second state projection image, and the non-deformed third state projection image. Step S412 of FIG. 4A is similar to step S212 of FIG. 2A, and the similarities are not repeated here.

In step S414, a deformation parameter of the projecting device 110 is obtained. Since the first state image 510_a, the second state image 520_a, the third state image 530_a, the first state projection image 510_b, the second state projection image 520_b and the third state projection image 530_b have been processed with the undistortion process, a box having straight lines is defined on the above undistorted images. The box should also have straight lines in the three-dimensional space. Therefore, a box can be defined on one of the non-deformed first state projection image, the non-deformed second state projection image, and the non-deformed third state projection image. The box has a rectangular shape. By corresponding the pixel points on the four edges of the box to the projection pattern, a corresponding box can be obtained on the projection pattern. When projecting the projection pattern, if the casting lens of the projecting device 110 enables the image projected on the calibration board 190 to be deformed, then the corresponding box of the projection pattern defined in one of the non-deformed first state projection image, the non-deformed second state projection image, and the non-deformed third state projection image can be a trapezoid instead of a rectangle. The deformation parameter of the projecting device 110 can be obtained through the calculation of formula 3, formula 4, and formula 5 according to the box defined according to one of the non-deformed first state projection image, the non-deformed second state projection image, the non-deformed third state projection image, and the corresponding box on the projection pattern.

Then, the method proceeds to step S416, an intrinsic parameter of the projecting device 110 is obtained through the calculation of formula 1 and formula 2 according to the first set, the second set and the third set of coordinate values of corresponding points obtained in step S412.

In step S418, a rectification process is performed using an image transformation matrix between the image sensing device 120 and the projecting device 110, wherein the image transformation matrix is obtained according to the first set, the second set and the third set of coordinate values of corresponding points.

Then, the method proceeds to step S420, the three-dimensional coordinate values of each feature point on the calibration board 190 are obtained according to the intrinsic parameters of the image sensing device and the coordinate values of the calibration points of the calibration board 190.

In step S422, a projection matrix between the image sensing device 120 and the projecting device 110 is obtained according to the three-dimensional coordinate values of each feature point on the calibration board 190 obtained in step 420, the first, the second set and the third set of coordinate values of corresponding points that corresponding to the feature points in the projection pattern, the intrinsic parameters of the intrinsic parameters of the image sensing device 120, and the intrinsic parameters of the projecting device 110. The projection matrix is formed of the extrinsic parameters between the image sensing device 120 and the projecting device 110. Steps S418, S420 and S422 are similar to steps S218, S220 and S222 of FIG. 2A, and the similarities are not repeated here.

In an embodiment of the disclosure, the depth image capturing device 10 can be disposed on a robot arm. The robot arm can enable the depth image capturing device 10 to capture the image of the calibration board 190 from different angles, different positions or different states, such that the depth image capturing device 10 can be calibrated in a free pose mode. In another embodiment of the disclosure, the depth image capturing device 10 can be hand-held and operated by a user to capture the image of the calibration board 190 from different angles, different positions or different states.

In above embodiments of the disclosure, the depth image capturing device 10 captures the image of the calibration board 190 from different angles, different positions or different states to perform the calibration method of the depth image capturing device 10. However, the calibration method of the depth image capturing device 10 of the disclosure is not limited to being used in the depth image capturing device 10 capturing images from different angles, different positions or different states. The calibration board 190 can be disposed at different angles, different positions or different states, so that the depth image capturing device 10 can capture the image of the calibration board 190 from different angles, different positions or different states to perform the calibration method of the depth image capturing device 10.

According to the calibration method of a depth image capturing device disclosed in the embodiments of disclosure, the three-dimensional coordinate values of each feature point on the calibration board can be obtained according to the intrinsic parameters of the image sensing device and the intrinsic parameters of the projecting device, and the calibration platform can be dispensed with. When the depth image capturing device needs to be calibrated, the user can use a calibration board to calibrate the depth image capturing device without sending the depth image capturing device to the manufacturer for calibration or using a calibration platform. According to the calibration method of a depth image capturing device disclosed in the embodiments of disclosure, during calibration, the depth image capturing device does not need to be disposed on the calibration platform. Thus, a free pose mode can be achieved, and the user can have greater convenience in calibrating the depth image capturing device.

While the disclosure has been described by way of example and in terms of the preferred embodiment(s), it is to be understood that the disclosure is not limited thereto. On the contrary, it is intended to cover various modification and similar arrangements and procedures, and the scope of the appended claims therefore should be accorded the broadest interpretation so as to encompass all such modification and similar arrangements and procedures.

1. A calibration method of a depth image capturing device comprising a projecting device and an image sensing device, wherein the calibration method comprises:
capturing at least three groups of images of a calibration board having a plurality of feature points, wherein each of the at least three groups of images includes an image including a projection pattern projected on the calibration board by the projecting device and an image not including the projection pattern on the calibration board;
calibrating an intrinsic parameter of the image sensing device according to the at least three groups of images;
obtaining a plurality of sets of coordinate values of corresponding points corresponding to the feature points in the projection pattern of the projecting device;
calibrating an intrinsic parameter of the projecting device according to the intrinsic parameter of the image sensing device and the plurality of sets of coordinate values of corresponding points;
obtaining a three-dimensional coordinate value of each feature point according to the intrinsic parameter of the image sensing device; and
obtaining an extrinsic parameter between the image sensing device and the projecting device according to the three-dimensional coordinate values of the feature points, the plurality of sets of coordinate values of corresponding points, the intrinsic parameter of the image sensing device, and the intrinsic parameter of the projecting device.

2. The calibration method according to claim 1, further comprising obtaining a resolution of the image sensing device and a coordinate value of each feature point on the calibration board.

3. The calibration method according to claim 1, wherein the step of capturing the at least three groups of images of the calibration board by the image sensing device comprises:
capturing a first angle image of the calibration board by the image sensing device from a first angle, a second angle image of the calibration board by the image sensing device from a second angle and a third angle image of the calibration board by the image sensing device from a third angle; wherein the first angle, the second angle and the third angle are not the same;
disposing the depth image capturing device at a first position, wherein the image sensing device captures a first position image of the calibration board, the projecting device projects the projection pattern corresponding to the projection pattern to the calibration board, and the image sensing device senses the projection pattern projected on the calibration board to generate a first position projection image;
disposing the depth image capturing device at a second position, wherein the image sensing device captures a second position image of the calibration board, the projecting device projects the projection pattern to the calibration board, and the image sensing device senses the projection pattern projected on the calibration board to generate a second position projection image; and
disposing the depth image capturing device at a third position, wherein the image sensing device captures a third position image of the calibration board, the projecting device projects the projection pattern to the calibration board, and the image sensing device senses the projection pattern projected on the calibration board to generate a third position projection image.

4. The calibration method according to claim 3, wherein the depth image capturing device at the first position is separated from the calibration board by a first distance, the depth image capturing device at the second position is separated from the calibration board by a second distance, and the depth image capturing device at the third position is separated from the calibration board by a third distance;
wherein the first distance, the second distance and the third distance are not the same.

5. The calibration method according to claim 3, wherein the step of calibrating the intrinsic parameters of the image sensing device comprises:
calibrating the intrinsic parameters of the image sensing device according to the first angle image, the second angle image and the third angle image.

6. The calibration method according to claim 3, wherein the step of obtaining the plurality of sets of coordinate values of corresponding points corresponding to the feature points in the projection pattern comprises:
performing an undistortion process on the first position image, the second position image and the third position image according to a deformation parameter of the image sensing device to generate a non-deformed first position image, a non-deformed second position image and a non-deformed third position image;
performing an undistortion process on the first position projection image, the second position projection image and the third position projection image according to the deformation parameter of the image sensing device to generate a non-deformed first position projection image, a non-deformed second position projection image and a non-deformed third position projection image; and
obtaining a first set, a second set and a third set of coordinate values of the corresponding points corresponding to the feature points in the projection pattern by a block matching algorithm according to the projection pattern, the non-deformed first position image, the non-deformed second position image, the non-deformed third position image, the non-deformed first position projection image, the non-deformed second position projection image, and the non-deformed third position projection image.

7. The calibration method according to claim 1, wherein the step of capturing the at least three groups of images of the calibration board by the image sensing device comprises:
disposing the depth image capturing device in a first state, wherein the image sensing device captures a first state image of the calibration board, the projecting device projects the projection pattern to the calibration board, and the image sensing device senses the projection pattern projected on the calibration board to capture a first state projection image;
disposing the depth image capturing device in a second state, wherein the image sensing device captures a second state image of the calibration board, the projecting device projects the projection pattern to the calibration board, and the image sensing device senses the projection pattern projected on the calibration board to capture a second state projection image; and
disposing the depth image capturing device in a third state, wherein the image sensing device captures a third state image of the calibration board, the projecting device projects the projection pattern to the calibration board, and the image sensing device senses the projection pattern projected on the calibration board to capture a third state projection image.

8. The calibration method according to claim 7, wherein the depth image capturing device in the first state faces the calibration board from a first angle and is separated from the calibration board by a first distance; the depth image capturing device in the second state faces the calibration board from a second angle and is separated from the calibration board by a second distance; the depth image capturing device in the third state faces the calibration board from a third angle and is separated from the calibration board by a third distance;
wherein the first distance, the second distance and the third distance are not the same; the first angle, the second angle and the third angle are not the same.

9. The calibration method according to claim 7, wherein the step of calibrating the intrinsic parameters of the image sensing device comprises:
calibrating the intrinsic parameters of the image sensing device according to the first state image, the second state image and the third state image.

10. The calibration method according to claim 7, wherein the step of obtaining the plurality of sets of coordinate values of corresponding points corresponding to the feature points in the projection pattern comprises:
performing an undistortion process on the first state image, the second state image and the third state image according to a deformation parameter of the image sensing device to generate a non-deformed first state image, a non-deformed second state image and a non-deformed third state image;
performing an undistortion process on the first state projection image, the second state projection image and the third state projection image according to the deformation parameter of the image sensing device to generate a non-deformed first state projection image, a non-deformed second state projection image and a non-deformed third state projection image; and
obtaining a first set, a second set and a third set of coordinate values of the corresponding points corresponding to the feature points in the projection pattern by a block matching algorithm according to the projection pattern, the non-deformed first state image, the non-deformed second state image, the non-deformed third state image, the non-deformed first state projection image, the non-deformed second state projection image and the non-deformed third state projection image.

11. The calibration method according to claim 1, further comprising obtaining a deformation parameter of the projecting device according to at least one image of the at least three groups of images.

12. The calibration method according to claim 1, further comprising obtaining an image transformation matrix between the image sensing device and the projecting device to perform a rectification process according to the plurality of sets of coordinate values of corresponding points.

13. The calibration method according to claim 1, wherein the depth image capturing device is disposed on a robot arm.

14. The calibration method according to claim 1, wherein the feature points are arranged as window shaped 3×3 matrix of the calibration board.

15. The calibration method according to claim 1, wherein the projection pattern is a random pattern image.
